(19) United States
(12) Patent Application Publication
(10) Pub. No.: US 2025/0100228 A1
(43) Pub. Date: Mar. 27, 2025

(54) METHOD AND SYSTEM FOR PROCESSING GRAPHIC FOR LIGHT-CURED PRINTING

(71) Applicant: Shanghai Fusion Tech Co., Ltd., Shanghai (CN)

(72) Inventors: Wei Mai, Shanghai (CN); Sheng Zhu, Shanghai (CN); Chong Wang, Shanghai (CN); Jingjing Qian, Shanghai (CN); Hua Feng, Shanghai (CN); Jianzhe Li, Shanghai (CN); Jinjing Zhang, Shanghai (CN)

(73) Assignee: Shanghai Fusion Tech Co., Ltd., Shanghai (CN)

(21) Appl. No.: 18/830,620

(22) Filed: Sep. 11, 2024

(30) Foreign Application Priority Data
Sep. 22, 2023 (CN) 202311231831.5

(51) Int. Cl. B29C 64/393; B29C 64/232; B29C 64/245; B33Y 10/00; B33Y 50/02

(52) U.S. Cl. CPC B29C 64/393; B29C 64/232; B29C 64/245; B33Y 10/00; B33Y 50/02

(57) ABSTRACT

Methods and systems for processing a graphic for light-cured printing, an electronic apparatus, and/or a storage medium are disclosed. In some embodiments, the method includes following steps: obtaining 3D model data of an object to be printed; slicing the 3D model data to obtain sliced data; converting the sliced data to a projected picture; and chunking the projected picture to obtain a plurality of exposed pictures. The plurality of exposed pictures are superimposed and intersected to have an exposed result of the projected picture. In other embodiments, the method includes following steps: placing a photosensitive resin in a material tray, placing a molding platform in the material tray, and placing a molding end surface of the molding platform in contact with the photosensitive resin; sending the plurality of exposed pictures to a bottom surface of the material tray; and curing a corresponding layer of photosensitive resin.

### CROSS REFERENCE TO RELATED APPLICATIONS

This application claims priority to Chinese patent application number 202311231831.5, filed on Sep. 22, 2023, the disclosure of which is incorporated by reference herein in its entirety.

### FIELD OF THE DISCLOSURE

The disclosure relates generally to the field of computers. More specifically, the disclosure relates to methods and systems for processing graphic for light-cured printing, electronic apparatus, and storage mediums.

### BACKGROUND

An existing light-cured printer needs to slice 3D model data first, and then converts the sliced data into a projected picture. Exposure of a large cross-sectional area generates a large amount of heat during a resin curing process. The continued accumulation of heat may damage a release film. In addition, because the transformation of light-cured resin from liquid to solid is accompanied by severe volume contraction, when encountering a continuous large cross-sectional area, a large shrinkage stress accumulates between layers, leading to deformation. Further, a pulling force during a release process shows a positive correlation with the cross-sectional area of exposure and curing. A much greater pulling force may lead directly to model detachment, support breakage, and print failure.

Therefore, there is an urgent need for a method for processing a graphic for light-cured printing that directly reduces the cross-sectional area of a single exposure.

### SUMMARY

The following presents a simplified summary of the invention in order to provide a basic understanding of some aspects of the invention. This summary is not an extensive overview of the invention. It is not intended to identify critical elements or to delineate the scope of the invention. Its sole purpose is to present some concepts of the invention in a simplified form as a prelude to the more detailed description that is presented elsewhere.

In some embodiments, the disclosure provides a method for processing a graphic for light-cured printing, including following steps: obtaining 3D model data of an object to be printed, slicing the 3D model data to obtain sliced data, converting the sliced data to a projected picture, and chunking the projected picture to obtain a plurality of exposed pictures. The plurality of exposed pictures are superimposed and intersected to produce an exposed result of the projected picture.

Optionally, the method further includes following steps: placing a photosensitive resin in a material tray, placing a molding platform in the material tray, and placing a molding end surface of the molding platform in contact with the photosensitive resin; sending the plurality of exposed pictures to a bottom surface of the material tray; and curing a corresponding layer of photosensitive resin.

Optionally, the method further includes following steps: after printing a previous layer of cured photosensitive resin, driving, by a lifting mechanism, the molding platform to move upward for a certain distance; printing a shape of a next layer based on the previous layer of cured photosensitive resin and curing the next layer; and superimposing layer by layer until printing is completed.

Optionally, the method further includes following steps: collecting image information of a printing process of a light-cured printer by a camera; importing the image information into a trained printing state analysis model to obtain a printing state analysis result; and controlling the light-cured printer based on the printing state analysis result.

Optionally, the method further includes following steps: obtaining historical image information collected by a camera and extracting feature information of the historical image information; constructing a training set based on the feature information; and training a printing state analysis model based on the training set to obtain a trained printing state analysis model.

Optionally, the method further includes following steps: dividing the feature information into a training set, a validation set, and a test set; training the printing state analysis model based on the training set; evaluating a performance of the trained printing state analysis model based on the validation set to obtain a printing state analysis model satisfying performance conditions; and evaluating an analysis result of the printing state analysis model satisfying the performance conditions based on the test set to obtain an evaluation index corresponding to the printing state analysis model satisfying the performance conditions.

Optionally, the method further includes following steps: when a printing status is determined to be abnormal, stopping to print a first layer of exposed picture and a second layer of exposed picture uploaded by a current user, storing video data of an entire process from a start to a failure, uploading the video data to a cloud server as a failure analysis record, and analyzing the failure analysis record and generating an error log.

In other embodiments, the disclosure provides an electronic apparatus, including a memory, a processor, and computer program stored on the memory and executable on the processor, the processor being configured to implement steps of the aforementioned methods when executing the computer program.

In further embodiments, the disclosure provides a non-transitory computer readable storage medium, having a computer program stored thereon, the computer program, when executed by a processor, implementing steps of the method according to aforementioned method.

In some embodiments, the disclosure provides a system for processing a graphic for light-cured printing, including: an obtaining module configured to obtain 3D model data of an object to be printed; a slicing module configured to slice the 3D model data to obtain sliced data; a converting module configured to convert the sliced data into a projected picture; and a chunking module configured to chunk the projected picture to obtain a plurality of exposed pictures, the plurality of exposed pictures being superimposed and intersected to produce an exposed result of the projected picture.

In other embodiments, the disclosure provides an embodiment of the disclosure provides a method for processing a graphic for light-cured printing, including the following steps: obtaining 3D model data of an object to be printed; slicing the 3D model data to obtain sliced data; converting the sliced data to a projected picture; chunking the projected picture to obtain a plurality of exposed pictures. The plurality of exposed pictures are superimposed and intersected to have the exposed result of the projected picture.

Optionally, the method for processing the graphic for the light-cured printing further includes the following steps: placing photosensitive resin in a material tray, placing a molding platform in the material tray, and placing the molding end surface of the molding platform in contact with the photosensitive resin; sending the plurality of exposed pictures to a bottom surface of the material tray and curing a corresponding layer of photosensitive resin.

Optionally, the method for processing the graphic for the light-cured printing further includes the following steps: after printing, driving, by a lifting mechanism, the molding platform to move upward for a certain distance, printing the shape of a next layer on the basis of a previous layer of cured photosensitive resin, and superimposing the cured photosensitive resin layer by layer until the printing is completed.

Optionally, the method for processing the graphic for the light-cured printing further includes the following steps: collecting image information by a camera; collecting image information of a print process of a light-cured printer by the camera; importing the image information into a trained printing state analysis model to obtain a printing state analysis result; controlling a light-cured printer based on the printing state analysis result.

Optionally, the method for processing the graphic for the light-cured printing further includes the following steps: obtaining historical image information collected by a camera and extracting feature information of the historical image information; constructing a training set based on the feature information; training the printing state analysis model based on the training set to obtain the trained printing state analysis model.

Optionally, the method for processing the graphic for the light-cured printing further includes the following steps: dividing the feature information into a training set, a validation set, and a test set; training the printing state analysis model based on the training set; evaluating a performance of the trained printing state analysis model based on the validation set to obtain the printing state analysis model that satisfies performance conditions; evaluating the analysis result of the printing state analysis model satisfying the performance conditions based on the test set to obtain an evaluation index corresponding to the printing state analysis model.

Optionally, the method for processing the graphic for the light-cured printing further includes the following steps: when the printing status is determined to be abnormal, stopping to print a first layer of exposed picture and a second layer of exposed picture uploaded by a current user, storing video data of an entire process from the start of printing to the failure process, and uploading the video data to a cloud server as a failure analysis record; analyzing the failure analysis record and generating an error log.

In further embodiments, the disclosure provides a system for processing a graphic for light-cured printing includes: an obtaining module, configured to obtain 3D model data of an object to be printed; a slicing module, configured to slice the 3D model data to obtain sliced data; a converting module, configured to convert the sliced data into a projected picture; a chunking module, configured to chunk the projected picture to obtain a plurality of exposed pictures. The plurality of exposed pictures are superimposed and intersected to have the exposed result of the projected picture.

Optionally, the disclosure provides an electronic apparatus includes a memory, a processor, and computer program stored on the memory and executable on the processor. The processor implements the steps of the method when executing the computer program.

Optionally, the disclosure provides a non-transitory computer readable storage medium that has computer program stored thereon. The computer program, when executed by a processor, implements the steps of the method.

### BRIEF DESCRIPTION OF THE DRAWINGS

Illustrative embodiments of the present disclosure are described in detail below with reference to the attached drawing figures.

FIG. 1 shows a flowchart of a method for processing a graphic for light-cured printing according to an embodiment of the disclosure.

FIG. 2 shows a first architectural diagram of a method for processing a graphic for light-cured printing according to an embodiment of the disclosure.

FIG. 3 shows a second architectural diagram of a system for processing a graphic for light-cured printing according to an embodiment of the disclosure:

FIG. 4 shows a projected picture for light-cured printing according to an embodiment of the disclosure.

FIG. 5 shows a first exposed picture for light-cured printing according to an embodiment of the disclosure.

FIG. 6 shows a second exposed picture for light-cured printing according to an embodiment of the disclosure.

FIG. 7 shows a schematic diagram of a solid structure of an electronic apparatus according to an embodiment of the disclosure.

### DETAILED DESCRIPTION

The following describes some non-limiting exemplary embodiments of the invention with reference to the accompanying drawings. The described embodiments are merely a part rather than all of the embodiments of the invention. All other embodiments obtained by a person of ordinary skill in the art based on the embodiments of the disclosure shall fall within the scope of the disclosure.

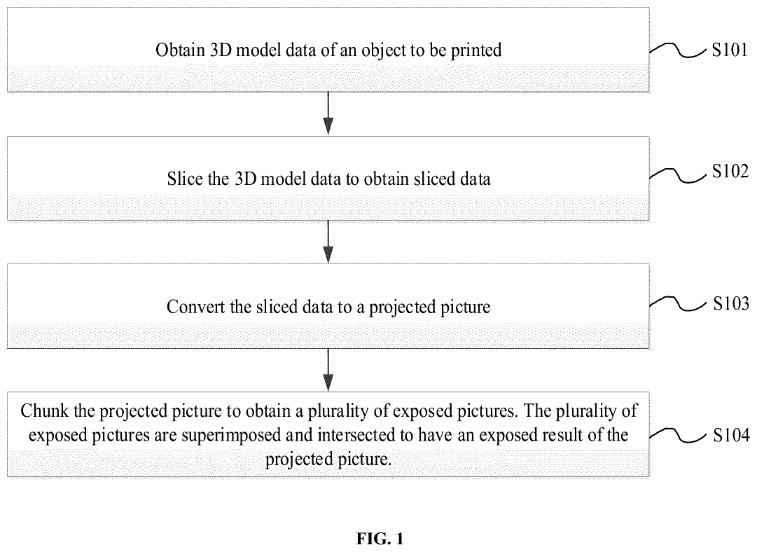

In FIGS. 1 through 7, 10 represents obtaining module, 20 represents slicing module, 30 represents converting module, 40 represents chunking module, 50 represents collecting module, 60 represents printing state analysis model, 70 represents anomaly feedback module, 80 represents electronic apparatus, 801 represents processor, 802 represents memory, and 803 represents bus.

### Embodiments

FIG. 1 is a flowchart of an embodiment of a method for processing a graphic for light-cured printing of the disclosure. As shown in FIG. 1, an embodiment of the disclosure provides a method for processing a graphic for light-cured printing, including the following steps:
S101: obtaining 3D model data of an object to be printed.

Optionally, generating a 3D model of the object to be printed by 3D modeling, or scanning the object to be printed via a 3D scanner to obtain the 3D model of the data of the object to be printed, and sending the data of the 3D model to a server of a light-cured printer.
S102: slicing the 3D model data to obtain sliced data.

Optionally, the server of the light-cured printer, upon receiving the data of the 3D model, controls first slicing program in the server to slice the 3D model to obtain sliced data initially to be analyzed.
S103: converting the sliced data to a projected picture.

Optionally, when there is the large cross-sectional area of exposure of the projected picture, a large amount of heat is generated during the curing process of resin. The continued accumulation of heat may damage a release film. In addition, because the transformation of light-cured resin from liquid to solid is accompanied by severe volume contraction, when encountering a continuous large cross-sectional area, a large shrinkage stress accumulates between the layers, leading to deformation. Further, a pulling force during a release process shows a positive correlation with the cross-sectional area of the exposure and curing. A much greater pulling force may lead directly to model detachment, support breakage, and print failure.

Therefore, there is a need to find a method to reduce a pulling force during a print process, reduce the deformation of a printed model, and reduce the damage to a release film during curing and release processes.
S104: chunking the projected picture to obtain a plurality of exposed pictures. The plurality of exposed pictures are superimposed and intersected to have the exposed result of the projected picture.

Optionally, reference is made to the concrete pouring program of the Hoover Dam in the United States. When concrete is cured, a hydration reaction of the concrete slowly releases a large amount of heat. Engineers assessed that it would take 125 years for the entire dam to cool down if the dam was poured as a whole. When the degrees of cooling and heat dissipation are inconsistent between inside and outside, it may lead to serious problems such as cracking of the concrete. Therefore, the strategy of casting in pieces was adopted.

A similar problem exists in face-exposure light-cured 3D printing technology. When a large section is exposed in entirety, an internal stress of tremendous amounts of heat is generated. The strategy of using staggered and chunked exposures directly reduces the cross-sectional area of a single-layer exposure, dividing a large continuous section into smaller chunks.

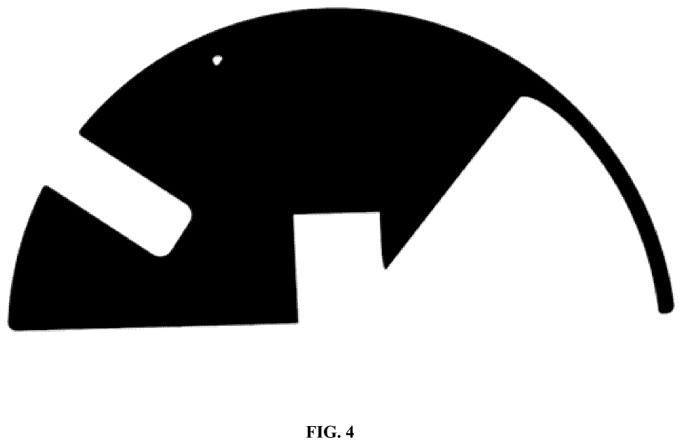

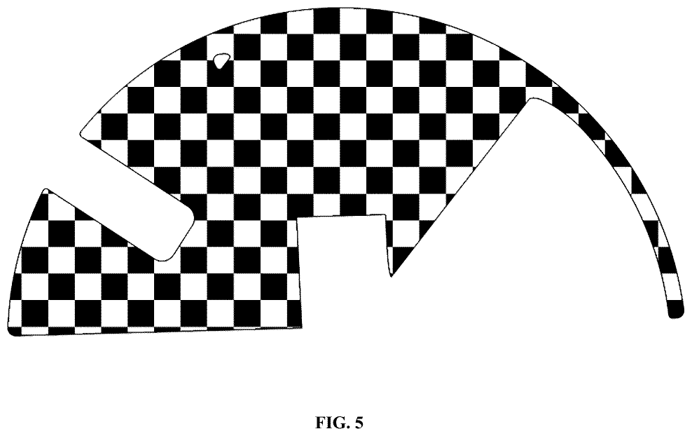

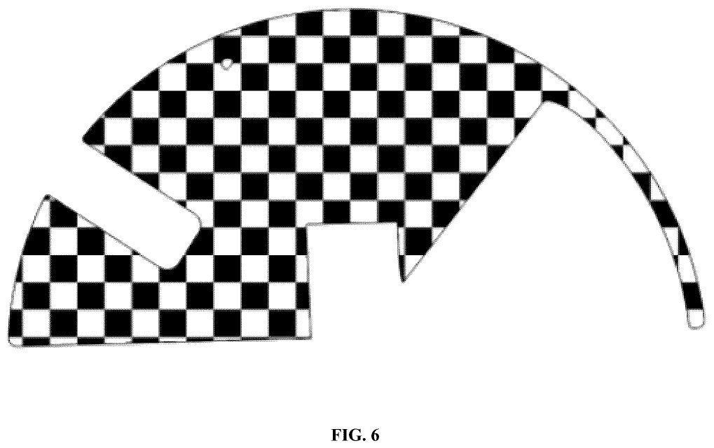

FIG. 4 is an original conventional projected picture of a layer. FIGS. 5 and 6 are exposed pictures of front and back layers after chunked. The result of intersecting these two layers just happens to be the exposed result in FIG. 4. By means of this chunking exposure way, an originally continuous large cross-sectional area is shared over two exposures.

The method for processing the graphic for the light-cured printing adopts a chunking exposure strategy. An original layer of a continuous solid large cross-sectional area is divided by two exposures. Based on a continuous solid cross-section chunking solution, the continuous solid large cross-sectional area not only may be divided into two, but also may be divided into three. Chunking exposures may have surface quality problems. Therefore, a contour zone (an outer surface layer) of the model is not involved in chunking.

The method for processing the graphic for the light-cured printing may include the following steps: obtaining the 3D model data of an object to be printed; slicing the 3D model data to obtain the sliced data; converting the sliced data to the projected picture; and chunking the projected picture to obtain the plurality of exposed pictures. The plurality of exposed pictures are superimposed and intersected to have the exposed result of the projected picture. The method may help to solve the problems in the prior art in which the large cross-sectional area of exposure during a print process may lead to serious damage to a release film during curing and release processes; a pulling force during the release process is positively correlated with the cross-sectional area of exposure and curing, and the larger cross-sectional area of the exposure and the curing may result in a larger pulling force, which may lead to model dislodgement, support breakage, and print failure, thereby directly reducing the cross-sectional area of single exposure.

The method for processing the graphic for the light-cured printing further may include the following steps:
placing photosensitive resin in a material tray, placing a molding platform in the material tray, and placing the molding end surface of the molding platform in contact with the photosensitive resin;
sending the plurality of exposed pictures to the bottom surface of the material tray and curing a corresponding layer of photosensitive resin.
after printing, driving, by a lifting mechanism, the molding platform to move upward for a certain distance, printing the shape of a next layer based on a previous layer of cured photosensitive resin, and superimposing the cured photosensitive resin layer by layer until the printing is completed.
collecting image information of a print process of a light-cured printer by a camera;
importing the image information into a trained printing state analysis model 60 to obtain a printing state analysis result;
controlling a light-cured printer based on the printing state analysis result.
obtaining historical image information collected by the camera and extracting feature information of the historical image information;
constructing a training set based on the feature information;
training the printing state analysis model 60 based on the training set to obtain the trained printing state analysis model 60.

Dividing the feature information into a training set, a validation set, and a test set;
training the printing state analysis model 60 based on the training set 60;
evaluating the performance of the trained printing state analysis model 60 based on the validation set to obtain the printing state analysis model 60 satisfying performance conditions;
evaluating the analysis result of the printing state analysis model 60 satisfying the performance conditions based on the test set to obtain an evaluation index corresponding to the printing state analysis model.
evaluating the performance of the trained printing state analysis model 60 based on the validation set to obtain the printing state analysis model 60 that satisfies performance conditions; evaluating the analysis result of the printing state analysis model 60 satisfying the performance conditions based on the test set to obtain an evaluation index corresponding to the printing state analysis model 60. The performance of the printing state analysis model 60 is evaluated to obtain a percentage score (i.e., a maximum score of 100 and a minimum score of 0). Based on the percentage score, the printing state analysis model 60 with a score greater than a set value is determined, e.g., the printing state analysis model 60 with a score greater than 90 is the printing state analysis model 60 that satisfies the performance conditions.

The printing state analysis model 60 satisfying the performance conditions is calculated with an evaluation index to obtain an evaluation index of the printing state analysis model 60. An evaluation value corresponding to each evaluation index is calculated and obtained. The evaluation value is configured to represent a capability value of the printing state analysis model 60 on the evaluation index.

When a printing status is determined to be abnormal, a first layer of exposed picture and a second layer of exposed picture uploaded by a current user stop to be printed. The video data of an entire process from the start of printing to a failure process are stored. The video data are uploaded to a cloud server as a failure analysis record. The failure analysis record is analyzed, and an error log is generated.

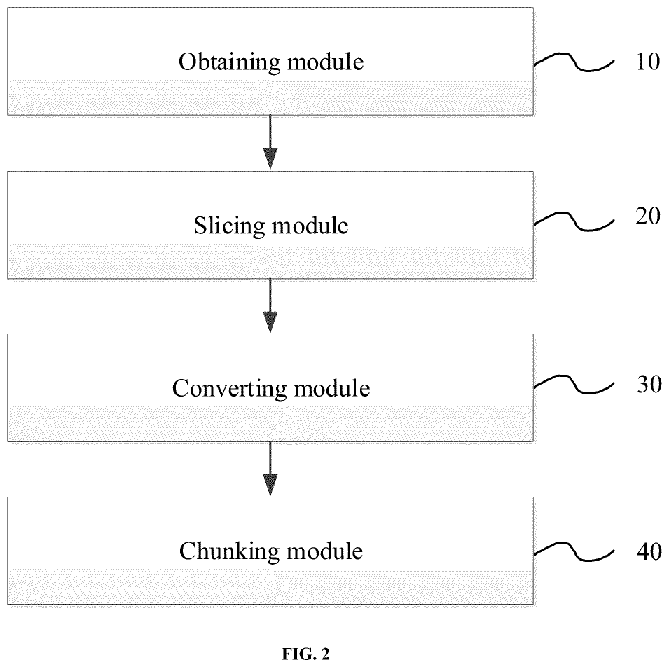

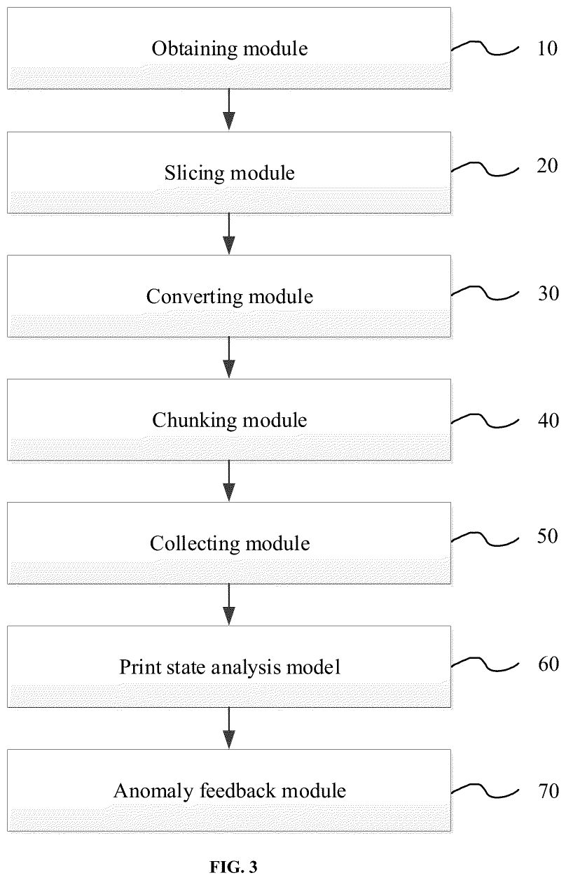

FIGS. 2-3 are flowcharts of an embodiment of a system for processing a graphic for light-cured printing of the disclosure. As shown in FIGS. 2-3, an embodiment of the disclosure provides a system for processing a graphic for light-cured printing, including:
an obtaining module 10, configured to obtain 3D model data of an object to be printed;
a slicing module 20, configured to slice the 3D model data to obtain sliced data;
a converting module 30, configured to convert the sliced data into a projected picture;
a chunking module 40, configured to chunk the projected picture to obtain a plurality of exposed pictures. The plurality of exposed pictures are superimposed and intersected to have the exposed result of the projected picture.

Photosensitive resin is placed in a material tray. A molding platform is placed in the material tray. The molding end surface of the molding platform is in contact with the photosensitive resin.

The plurality of exposed pictures are sent to the bottom surface of the material tray. A corresponding layer of photosensitive resin is cured.

After printing, the molding platform is driven by a lifting mechanism to move upward for a certain distance. The shape of a next layer is printed on the basis of a previous layer of cured photosensitive resin. The cured photosensitive resin is superimposed layer by layer until the printing is completed.
a collecting module 50, configured to collect image information of a print process of a light-cured printer by a camera;
a printing state analysis model 60, configured to obtain a printing state analysis result based on the image information; and
an anomaly feedback module 70, configured to stop to print a first layer of exposed picture and a second layer of exposed picture uploaded by a current user when a printing status is determined to be abnormal, store the video data of an entire process from the start of printing to the failure process, upload the video data to a cloud server as a failure analysis record, analyze the failure analysis record and generate an error log.

For a system for processing a graphic for light-cured printing, the 3D model data of an object to be printed is obtained by an obtaining module 10. The 3D model data is sliced to obtain the sliced data by a slicing module 20. The sliced data are converted to the projected picture by a converting module. The projected picture is chunked by a chunking module 40 to obtain a plurality of exposed pictures. The plurality of exposed pictures are superimposed and intersected to produce an exposed result of the projected picture. The method for processing the graphic for the light-cured printing solves the problems in the prior art in which the large cross-sectional area of the exposure during the print process may lead to serious damage to the release film during the curing and release processes; the pulling force during the release process is positively correlated with the cross-sectional area of the exposure and the curing, and the larger cross-sectional area of the exposure and the curing may result in the larger pulling force, which may lead to the model dislodgement, the support breakage, and the print failure.

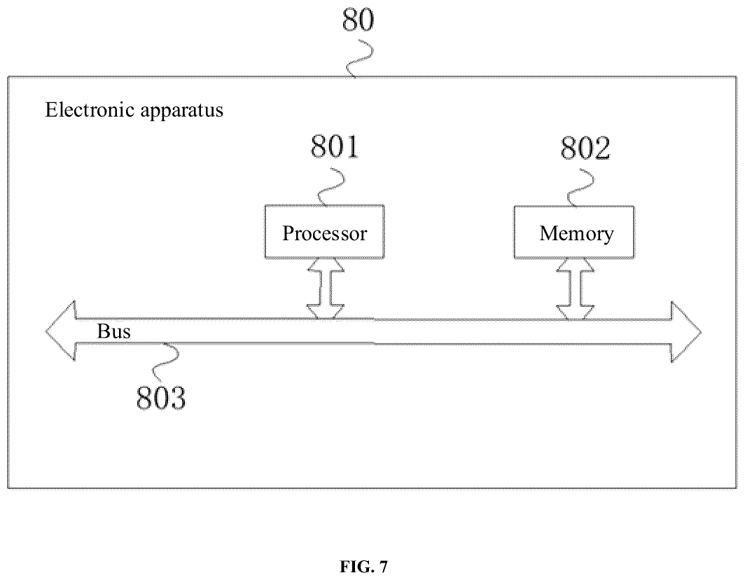

FIG. 7 is a schematic diagram of a physical structure of an electronic apparatus provided by an embodiment of the disclosure. As shown in FIG. 7, the electronic apparatus 80 may include a processor 801, a memory 802, and a bus 803.

The processor 801 and the memory 802 perform communication with each other via the bus 803.

The processor 801 is configured to call program instructions in the memory 802 to execute the method provided by each of the forgoing method embodiments. For example, the method may include the following steps: obtaining the 3D model data of an object to be printed; slicing the 3D model data to obtain the sliced data; converting the sliced data to the projected picture; and chunking the projected picture to obtain the plurality of exposed pictures. The plurality of exposed pictures are superimposed and intersected to produce an exposed result of the projected picture.

This embodiment provides a non-transitory computer-readable storage medium. The non-transitory computer-readable storage medium stores computer instructions. The computer instructions cause a computer to execute the method provided in each of the forgoing method embodiments. For example, the method may include the following steps: obtaining the 3D model data of an object to be printed; slicing the 3D model data to obtain the sliced data; converting the sliced data to the projected picture; and chunking the projected picture to obtain the plurality of exposed pictures. The plurality of exposed pictures are superimposed and intersected to produce an exposed result of the projected picture.

A person of ordinary skill in the art may understand that: all or some of the steps for realizing the forgoing method embodiments may be accomplished by hardware associated with program instructions. The foregoing program may be stored in a computer-readable storage medium which, when executed, performs the steps including the forgoing method embodiments. The foregoing storage medium may include a variety of storage media such as a ROM, a RAM, a magnetic disk, or a CD-ROM, etc., which may store a program code.

Device embodiments described above are merely schematic. In addition, a unit described as a separate component may or cannot be physically separated. The component displayed as the unit may or cannot be a physical unit, that is, the units may be located in one place, or may be distributed on a plurality of network units. Part or all of the modules may be selected according to actual needs to achieve the objective of the solution of the embodiment. It may be understood and implemented by a person skilled in the art without creative labor.

With the forgoing description of the implementation, it is clear for a person skilled in the art that each implementation may be realized with the help of software plus a necessary common hardware platform, and of course also with hardware. Based on this understanding, the technical solution of the disclosure, in essence or as a contribution to the prior art, may be embodied in the form of a software product. The software product of a computer may be stored in a computer-readable storage medium, such as a ROM/RAM, a disk, a CD-ROM, or the like, and may include a plurality of instructions so that one computer apparatus (which may be a personal computer, a server, or a network apparatus, or the like) carries out the method described in each embodiment or in some portions of embodiments.

Although, the disclosure has been described in detail above with a general description and specific embodiments, some modifications or improvements may be made on the basis of the disclosure, as will be apparent to a person skilled in the art. Therefore, these modifications or improvements made without departing from the spirit of the disclosure fall within the scope of the protection of the disclosure.

Various embodiments of the disclosure may have one or more of the following effects. In some embodiments, the disclosure may provide a method and system for processing a graphic for light-cured printing, an electronic apparatus, and a storage medium. The disclosure may help to solve the problems in the prior art such as: a large cross-sectional area of exposure during a print process may lead to serious damage to a release film during curing and release processes; a pulling force during the release process may be positively correlated with the cross-sectional area of the exposure and curing; and a larger cross-sectional area of the exposure and the curing may result in a larger pulling force, which may lead to model dislodgement, support breakage, and/or print failure. In further embodiments, the disclosure may provide a method for processing the graphic for the light-cured printing may include the following steps: obtaining the 3D model data of the object to be printed; slicing the 3D model data to obtain the sliced data; converting the sliced data to the projected picture; and chunking the projected picture to obtain a plurality of exposed pictures. The plurality of exposed pictures are superimposed and intersected to have the exposed result of the projected picture.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

The disclosure claimed is:

1. A method for processing a graphic for light-cured printing, comprising:
obtaining 3D model data of an object to be printed;
slicing the 3D model data to obtain sliced data;
converting the sliced data to a projected picture; and
chunking the projected picture to obtain a plurality of exposed pictures,
wherein the plurality of exposed pictures are superimposed and intersected to produce an exposed result of the projected picture.

2. The method according to claim 1, further comprising:
placing a photosensitive resin in a material tray, placing a molding platform in the material tray, and placing a molding end surface of the molding platform in contact with the photosensitive resin;
sending the plurality of exposed pictures to a bottom surface of the material tray; and
curing a corresponding layer of photosensitive resin.

3. The method according to claim 2, further comprising:
after printing a previous layer of cured photosensitive resin, driving, by a lifting mechanism, the molding platform to move upward for a certain distance;
printing a shape of a next layer based on the previous layer of cured photosensitive resin and curing the next layer; and
superimposing layer by layer until printing is completed.

4. The method according to claim 1, further comprising:
collecting image information of a printing process of a light-cured printer by a camera;
importing the image information into a trained printing state analysis model to obtain a printing state analysis result; and
controlling the light-cured printer based on the printing state analysis result.

5. The method according to claim 1, further comprising:
obtaining historical image information collected by a camera and extracting feature information of the historical image information;
constructing a training set based on the feature information; and
training a printing state analysis model based on the training set to obtain a trained printing state analysis model.

6. The method according to claim 5, further comprising:
dividing the feature information into a training set, a validation set, and a test set;
training the printing state analysis model based on the training set;
evaluating a performance of the trained printing state analysis model based on the validation set to obtain a printing state analysis model satisfying performance conditions; and
evaluating an analysis result of the printing state analysis model satisfying the performance conditions based on the test set to obtain an evaluation index corresponding to the printing state analysis model satisfying the performance conditions.

7. The method according to claim 5, further comprising:
when a printing status is determined to be abnormal,
stopping to print a first layer of exposed picture and a second layer of exposed picture uploaded by a current user,
storing video data of an entire process from a start to a failure,
uploading the video data to a cloud server as a failure analysis record, and
analyzing the failure analysis record and generating an error log.

8. An electronic apparatus, comprising a memory, a processor, and computer program stored on the memory and executable on the processor, the processor being configured to implement steps of the method according to claim 1 when executing the computer program.

9. A non-transitory computer readable storage medium, having a computer program stored thereon, the computer program, when executed by a processor, implementing steps of the method according to claim 1.

10. A system for processing a graphic for light-cured printing, comprising:
an obtaining module configured to obtain 3D model data of an object to be printed;
a slicing module configured to slice the 3D model data to obtain sliced data;
a converting module configured to convert the sliced data into a projected picture; and
a chunking module configured to chunk the projected picture to obtain a plurality of exposed pictures, the plurality of exposed pictures being superimposed and intersected to produce an exposed result of the projected picture.
